(19) United States
(12) Patent Application Publication
(10) Pub. No.: US 2012/0009103 A1
(43) Pub. Date: Jan. 12, 2012

(54) BIODEGRADABLE DISPOSABLE LABWARES FOR USE IN LABORATORIES

(76) Inventor: David Dehua Liu, Jericho, NY (US)

(21) Appl. No.: 12/832,020

(22) Filed: Jul. 7, 2010

(51) Int. Cl. C08G 63/08; C09K 3/00; C08L 67/04; B29C 45/00; B01L 3/08

(52) U.S. Cl. 422/556; 264/537; 528/354; 524/599; 252/182.14

(57) ABSTRACT

The present invention relates to plastic disposable supplies used in medical, biological, chemical and biochemical industries and laboratories. The disposable products of the present invention are manufactured by using a novel biodegradable plastic with composition modified from polylactic acid (PLA) plastic and additives under specific injection/blow molding conditions, thus possessing superior physical and chemical properties and being able to be degraded in nature without causing environmental contamination.

### BACKGROUND OF THE INVENTION

1. Field of the Invention

The present invention relates to plastic disposable supplies used in medical, biological, chemical and bio-chemical laboratories. The disposable supplies of the present invention are manufactured by using a novel biodegradable plastic with composition derived from polylactic acid (PLA) plastic under specific injection molding conditions, thus possessing superior physical and chemical properties and being able to be degraded in nature without causing environmental contamination.

2. Description of the Related Art

As one of the most popular materials, plastic is used in enormous and expending range of products, from shopping bags to car bumpers, displacing many traditional materials such as wood, steel, glass, ceramic, leather and cotton, due to its relatively low cost, ease of manufacture, inert to compounds and solvents. One biggest problem of using plastic is environmental concern in production and waste management, because plastic, especially petroleum-based plastic, is very durable and degrades very slowly in natural process for hundred or even thousand years.

Plastic materials used for making laboratory supplies are required to meet very strict criteria, especially for the products used in bio-science laboratories and chemical laboratories, from cell culture to chemical reactions, storage and transfer of strong acid/base/oxidant. They should be: chemically and physically stable in a range broader than the maximum and minimum temperature of usage; inert to strong acids, bases, oxidants and solvents commonly used in laboratories; very low absorption and adsorption to any chemicals/bio-chemicals, including water, salts, enzymes; non optic disturbance such as fluorescence or illuminant under ultra-violet; preferably clear and transparent or turn to opaque or colored after certain modifications; with good physical properties for injection/blow molding.

In medical, biological, chemical and biochemical laboratories, most of disposal supplies/consumables such as test tubes, pipette tips and racks, serological pipettes, culture plates/dishes/flasks and centrifuge tubes, primarily are made of plastic for cost saving, convenience, sterility, ready to use and performance. This has led to a growing amount of non degradable plastic waste that could be range from 10 s-100 s kg per month for a small laboratory.

One solution to above problem is to develop and use new kinds of plastics with a speedy and complete degradation as short as one year in a natural process such as exposures to sun light and bacterium in land fills, while maintaining all excellent properties of the conventional plastic prior its discarding. As an alternative to petroleum-based plastic, biodegradable plastic has been undergoing a fastest growth of demand in the past few years, as a result of higher capacity, greater production efficiencies, greater use of sustainable resources encouraged by growing environmental, governmental and consumer awareness and initiatives, and thus more competitiveness.

Biodegradable plastic produces only water and carbon dioxide and no hazardous during the complete degradation process and is considered most environmental friendly. However, one obstacle in applications of biodegradable plastics is their physical properties that are still lagging behind conventional plastics and not yet well qualified for good molding and quality products if there is no modification or blending to their original composition.

Poly-lactic acid or polylactide (PLA) is a biodegradable, thermoplastic, aliphatic polyester derived from renewable resources, such as corn starch or sugar canes. PLA of high molecular weight is produced in two steps: formation of cyclic lactide monomers by oligomerization and catalytic dimerization of lactic acid and then ring opening polymerization using a stannous octoate catalyst in industrial production or Sn(II) chloride in laboratory demonstration. Due to the chiral nature of lactic acid, polymerization of a racemic mixture of L- and D-lactide usually leads to the synthesis of poly-DL-lactide which is amorphous, however use of stereo-specific catalysts can leads to hetero-tactic PLA which has found to show crytallinity. The degree of crystallinity, and hence many important properties, is controlled by the ratio of D to L enantiomers used.

Although many efforts have been devoted in application of biodegradable plastic, including PLA, there has not been able to apply them to higher quality products with comparative chemical and physical properties to conventional plastic. A systematic study is desired to improve the PLA blending and production process for laboratory disposal supplies.

### SUMMARY OF THE INVENTION

Laboratory disposable supplies made of conventional petroleum based plastic have been a growing concern of environmental issue. Application of biodegradable plastic to such products has been experiencing difficulty due to its comparatively poor physical properties. The object of the invention is therefore to provide laboratory disposable supplies which can be degraded in nature without causing environmental contamination while having superior chemical and physical properties for quality products and good processing characteristics applicable to injection/blow molding.

### BRIEF DESCRIPTION OF DRAWINGS

FIG. 1 shows an injection molding system used to manufacture laboratory disposable supplies using biodegradable PLA plastic with specific components and optimized process conditions.

### DESCRIPTION OF THE INVENTION

The present invention is related to laboratory disposable supplies manufactured by injection/blow molding using biodegradable PLA plastic as the principle component in the composition.

The PLA plastic material of the present invention is a stereo-complex blend of PDLA and PLLA with percentage approximately 30/70, and it has 9,000-90,000 of number average molecular weight, and 40-150° C. of melting point, and it is not as stable as conventional plastic at higher temperature. To achieve better fluidity higher pressure is needed and applied to the injection process.

Different compounds which effectively modify properties of polymer products are blended into PLA in order to improve its physical and chemical properties, especially the properties related to processing and final products. Such additive compounds should completely miscible with the PLA polymer, nonvolatile, nontoxic, and non-migratory within the polymer. Optimal usage of the compounds is the minimum use while providing applicable processing condition, such as humidity, temperature and pressure, without compromising the quality of final products.

In the production process, fluidity of the material is a paramount importance. PLA has a poor fluidity for injection/blow molding. In the present invention, several compounds are used as fluidity enhancer or flow improver, they are tributyl citrate, polyolbenzoate, calcium stearate and/or magnesium stearate. Keeping the PLA molecular weight and transparency unchanged, optimal use of these compounds will greatly reduce the Van der Waals force within the PLA material and thus improve fluidity during the production process, especially for the thin and long articles. In addition to the improvement of fluidity during the process, these compounds act also as strength fortifying additive for the final products.

The use of tributyl citrate in weight percentage in the present invention is 0 to 2%, preferably 0.1 to 1.5%, most preferably 0.2 to 0.4%.

The use of polyolbenzoate in weight percentage in the present invention is 0 to 3%, preferably 0.4 to 2%, and most preferably 0.6 to 1%.

The use of calcium stearate or magnesium stearate in weight percentage in the present invention is 0 to 4%, preferably 1 to 3%, and most preferably 2 to 2.5%.

Electrostatic effect of the PLA material is another problem in the production process, in the present invention, ethylene bi-stearic acid amide is used as electrostatic elimination agent with weight percentage of 0.2 to 2%, preferably 0.3 to 1.5%, and most preferably 0.8 to 1.2%.

Polystyrene (PS) is one of the conventional plastic materials most commonly used for making laboratory disposable supplies and it can be used as a comparison for the polymer processing of the present invention.

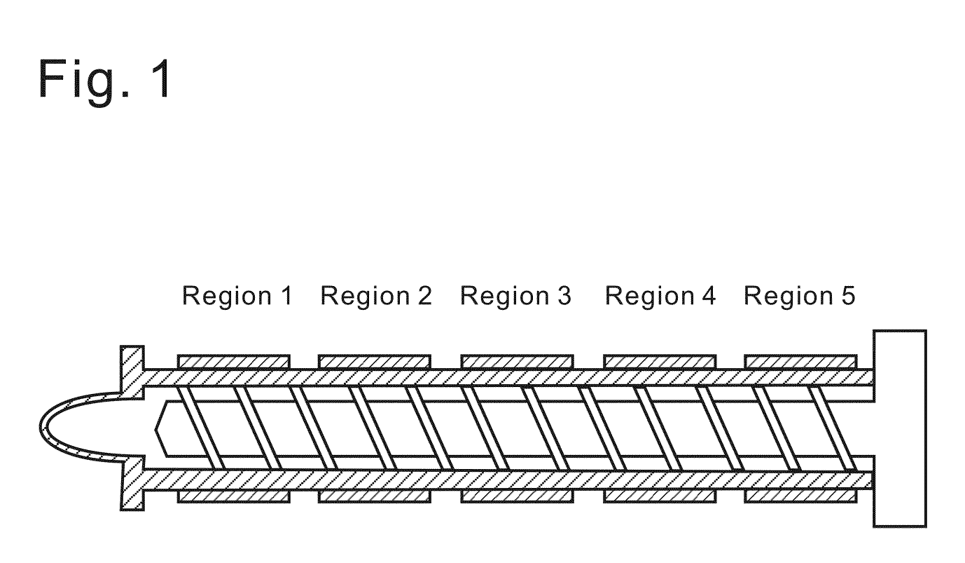

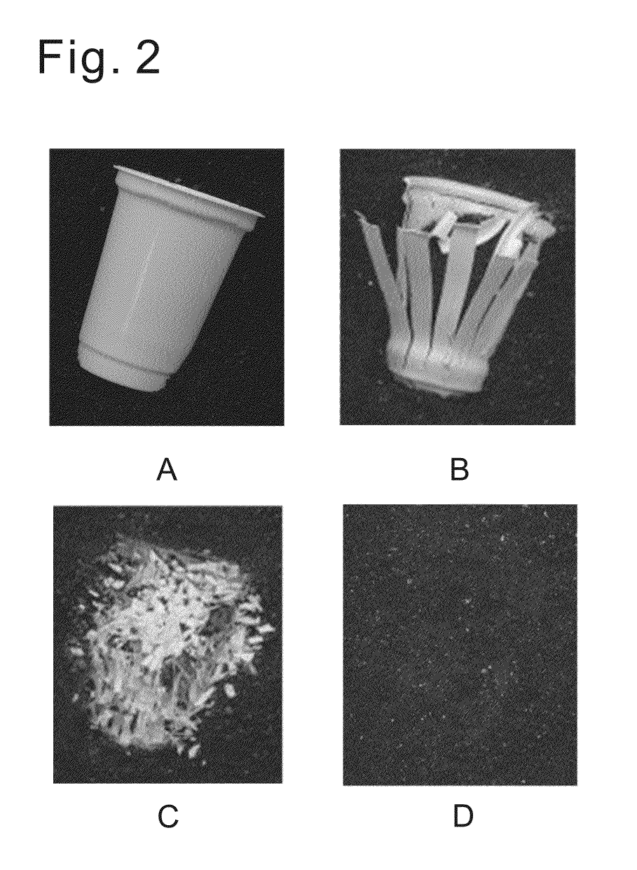

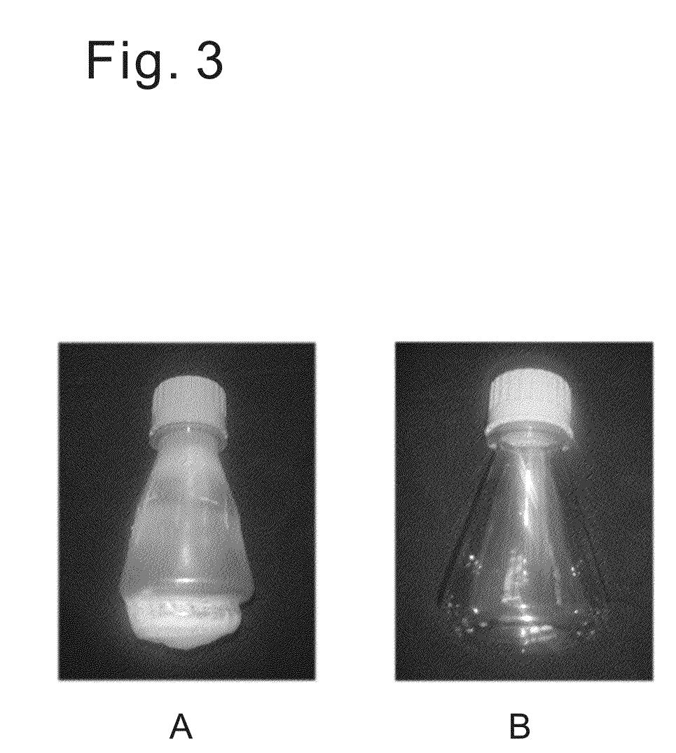

Temperature used in injection molding process for PLA is lower than conventional plastics as PLA can be decomposed at higher temperature. Addition of fluidity enhancers enables PLA with good fluidity at lower temperature and thus avoids any decomposition at higher temperature. A comparison for processing temperatures during injection molding process (FIG. 1) of PS and the modified PLA is shown in following Table 1.

TABLE 1

| Region of injection | Temperature | Temperature |
|---|---|---|
| molding | (° C.) for PS | (° C.) for PLA |
| Inlet | 50 | 0-20 |
| 1 | 200 | 140-160 |
| 2 | 210 | 140-170 |
| 3 | 230 | 150-180 |
| 4 | 230 | 170-200 |
| 5 | 230 | 180-205 |

Injection molding pressure applied for PS and modified PLA are 60-70 Mpa and 90-100 Mpa respectively.

A comparison for processing temperatures during the blow molding process of PS and the modified PLA is shown respectively in following Table 2.

TABLE 2

| Region of blow | Temperature (° C.) | Temperature (° C.) |
|---|---|---|
| molding | for PS | for modified PLA |
| Blow | 120 | 70-110 |
| Molding | 40-50 | 10-30 |

The biodegradable laboratory disposable supplies produced in accordance with the present invention can be in various forms, disposable dishes/flasks/bottles/plates, serological pipettes, pipette tips, test tubes, centrifuge tubes, vials, culture dishes, plates, storage tubes/bottles/boxes etc. Following examples are intended only to be illustrative of the present invention defined by the appended claims.

FIG. 2 shows a degradation process for an article made of modified PLA on day 1, day 50 and day 90 at temperature (56-60° C.) and humidity (80-90%) of compost. The article completely degraded after 90 days.

### Example 1

### Injection Molding

Lids of the disposable flasks were manufactured by using injection molding. FIG. 3 shows the products made of PLA and modified PLA according to the present invention under the same conditions listed in Table 1. It is shown that the cap of the flask made of modified PLA has better appearance and quality than that made of original PLA.

### Example 2

### Blow Molding

Bodies of the disposable flasks were manufactured by using blow molding. FIG. 3 shows the products made of PLA and modified PLA according to the present invention under the same conditions listed in Table 2. No quality body of the flask can be obtained using the original PLA because of poor fluidity and poor stability. In contrast, the body made of modified PLA according to the present invention has supper clarity and strength.

### Example 3

### Comparative Study

A comparative study has been done for flasks made of modified PLA biodegradable plastic according to the present invention, polystyrene, polypropylene and polycarbonate. The flasks are filled halfway with appropriate solvent and chemicals and are capped tightly and placed at 18-20° C. (Room Temperature) for 20 days with results observed on day 1st, 10th and 20th.

The results show the biodegradable flask made of modified PLA is more chemical resistant than the natural polystyrene. The modified PLA according to the present invention and the results are shown in Table 3.

TABLE 3

| | Modified | Polypropylene | Polystyrene | Polycarbonate |
|---|---|---|---|---|
| | Biodegraded | (PP) | (PS) | (PC) |
| Acids-dilute | ✓✓✓ | ✓✓✓ | ✓✓✓ | ✓✓✓ |
| Acid-concentrated | ✓✓✓ | ✓✓✓ | ✓ | X |
| Alcohols | ✓✓✓ | ✓✓✓ | ✓✓✓ | ✓✓ |
| Base | ✓✓✓ | ✓✓✓ | ✓✓✓ | X |
| Esters | — | ✓✓ | X | X |
| Hydrocarbons Aliphatic | ✓ | ✓✓ | X | X |
| Hydrocarbons Aromatics | ✓ | ✓ | X | X |
| Ketones | — | ✓✓ | X | X |
| Oils, Minerals | ✓✓✓ | ✓✓✓ | ✓✓✓ | ✓✓✓ |
| Oxidizing Agents | ✓ | ✓ | X | X |
| Max Temp. □ C. | 68 | 135 | 70 | 130 |
| Min Temp. □ C. | −20 | 0 | 0 | −135 |
| Autoclavable | No | Yes | No | Yes |
| Microwavability | No | Yes | No | Yes** |
| Gas Sterilization | Yes | Yes | Yes | Yes |
| Dry Heat Sterilization | No | No | No | No |
| γ Irradiation Sterilization | Yes | Yes | Yes | Yes |
| Chem. Disinfectant Ster. | Yes | Yes | Yes | Yes |
| Transparency | C | TL | C | TL |
| Flexibility | EX | R | R | R |
| Water absorption | <0.06 | <0.02 | 0.05 | <0.35 |
| Cytotoxicity* | No | No | No | No |

*“No” is based on the material being determined to be non-cytotoxic on USP and ASTM biocompatibility testing standards using an MEM elution technique on a W138 human diploid cell line.
**Material will absorb heat
***Following codes are used in the table:
✓✓✓ Excellent resistance, no attack.
✓✓ Good resistance, minor attack.
✓ Limited resistance, moderate attack, suitable for short term use only.
X Poor resistance not recommended.
C Clear
R Rigid
TL Translucent
EX Excellent

What is claimed is:

1. Biodegradable laboratory disposable supplies manufactured by means of injection/blow molding using biodegradable polylactide (PLA) with a modified composition.

2. The biodegradable laboratory disposable supplies in accordance to claim 1, wherein said PLA plastic comprising: a PLA blend, a fluidity enhancer and strength fortifier, and electrostatic elimination agent.

3. A PLA blend of claim 2, wherein the said blend is comprising a blend of stereo-complex PDLA and PLLA with percentage approximately 30/70, and it has 9,000-90,000 of number average molecular weight, and 40-150° C. of melting point;

4. A fluidity enhancer and strength fortifier of claim 2, for melted material during said molding process, a mixture of tributyl citrate, polyolbenzoate and calcium stearate or magnesium stearate, of which tributyl citrate has a weight percentage of 0 to 2%, preferably 0.1 to 1.5%, most preferably 0.2 to 0.4%; polyolbenzoate in weight percentage of 0 to 3%, preferably 0.4 to 2%, and most preferably 0.6 to 1%; calcium stearate or magnesium stearate in weight percentage of 0 to 4%, preferably 1 to 3%, and most preferably 2 to 2.5%; and

5. An electrostatic elimination agent of claim 2, ethylene bi-stearic acid amide with weight percentage of 0.2 to 2%, preferably 0.3 to 1.5%, and most preferably 0.8 to 1.2%.

6. The biodegradable disposable laboratory supplies in accordance to claims 1 to 4, wherein said injection molding is performed at 140-205° C.

7. The biodegradable disposable laboratory supplies in accordance to claims 1 to 4, wherein said blow molding is performed at 70-110° C. for blow temperature and at 10-30° C. for molding temperature.

8. The biodegradable disposable laboratory supplies in accordance to claims 1 to 4, wherein the final products are in forms of such as flasks, dishes, serological pipettes, bottles, plates, tubes, filters, filter units, pipettes, and pipette tips and other disposable supplies, used in medical, biological, chemical/biochemical and life scientific laboratories.
